(19) United States
(12) Patent Application Publication
(10) Pub. No.: US 2005/0219042 A1
(43) Pub. Date: Oct. 6, 2005

(54) Vehicle intruder alarm

(75) Inventor: Ian Robert Thomson, St.Neots (GB)

Correspondence Address: FLEIT KAIN GIBBONS GUTMAN BONGINI & BIANCO, COURVOISIER CENTRE II, SUITE 404, 601 BRICKELL KEY DRIVE, MIAMI, FL, 33131, US

(73) Assignee: TRUCKSAFE EUROPE LIMITED, CAMBRIDGE (GB)

(21) Appl. No.: 11/098,782

(22) Filed: Apr. 4, 2005

Related U.S. Application Data
(63) Continuation of application No. PCT/GB03/04259, filed on Oct. 3, 2003.

(30) Foreign Application Priority Data
Oct. 4, 2002 (GB) 0222966.4

(51) Int. Cl. B60R 25/10

(52) U.S. Cl. 340/426.1; 340/666; 340/686.1

(57) ABSTRACT

A vehicle alarm system that detects changes in weight of a load carried by the vehicle. Weight changes are detected by a sensor which measures the pressure within air suspension units, this pressure being a function of the weight carried.

### RELATED APPLICATION

This application is a continuation of International Application PCT/GB2003/004259, filed Oct. 3, 2003, the contents of which are here incorporated by reference in their entirety.

### BACKGROUND OF THE INVENTION

1. Field of the Invention

The present invention relates to an intruder alarm for a vehicle, which invention is applicable with particular advantage to detection of intruders in trucks and lorries.

2. Prior Art

A continuing and seemingly increasing problem is the entry into a country of illegal immigrants whilst stowed away in a concealed area in a vehicle without the knowledge of the driver. This is a particular problem for truck and lorry drivers travelling across borders, either land borders or sea borders. Not only can the driver be fined a large amount, he may also acquire a criminal record, unless he can prove that he did not know of the presence of the stowaways. The levels of fines in this area are high—for example in the UK the fine for a driver is £2000 per illegal immigrant found within his vehicle. The aim is to deter such use of vehicles by asking the drivers to exercise extreme vigilance at all times whilst in control of their vehicles.

However, on many vehicles there are potential concealment zones—areas which are hidden from the driver when he is in his cab or driving position. In the following specification the term ‘driver's cab’ will be used to encompass the area of any vehicle in the immediate vicinity of the driver's seat. In a truck, this is literally a cab, but in a coach or bus this also encompasses the driver's seat and its surrounding area. The term ‘concealment zone’ is used to encompass any area of a vehicle, not readily visible to a driver while in his cab while offering enough space to accommodate a stowaway. Typically the concealment zone for a truck or lorry will be in the cargo holding area which will be checked on loading and unloading the vehicle but cannot be checked each time a driver has to stop. The volume of vehicles entering a border is much too high for Customs and Immigration of that country to be able to search each vehicle. As an example, around 86,000 vehicles arrive through the UK ports in one week. In order to transport a cargo across borders there are many papers and formalities which need to be fulfilled by the driver, especially at Customs and the driver may have to leave his vehicle for long periods to complete such formalities. Whilst away from the vehicle it is possible for illegal immigrants to enter the vehicle and hide himself or themselves in a concealment zone of the truck. On return to the vehicle the driver will have no indication that there has been any entry of unauthorised personnel into his vehicle.

### SUMMARY OF THE INVENTION

According to the invention there is provided a vehicle alarm system comprising means (71) for generating an alarm signal in response to a weight change characterised in that the means for generating the alarm includes a sensor (57) mounted upon or within an air suspension unit (51, 55) of the vehicle (49).

Such an alarm system preferably only operates when the vehicle is stationary, although there may be circumstances when the alarm system is operable when the vehicle is moving at low speeds. The system preferably includes an activator, e.g. a switch, which allows the driver to switch on his alarm when leaving the vehicle and switch it back off on returning to the vehicle. Alternatively, the activator may automatically activate the system when the vehicle is stationary. This would then have the advantage that if the driver were to have to stop his vehicle in a long line of traffic his alarm system would automatically be activated. The alarm system may include a detector for detecting when the driver has left the vehicle or where the alarm system is built into the vehicle it may be coupled to the onboard computer of the vehicle and thus be activated when the vehicle is stationary. The system may operate by only switching on the sensor when the alarm system is activated or may be arranged such that the sensor continuously monitors the forces applied within the concealment zone but the alarm generator only operates to generate an alarm when the system is activated.

The may be an audible alarm mounted within the vehicle. However, preferably the alarm provides an indication at a remote location. In the case of trucks they are likely to be part of a larger fleet where the fleet is managed and in communication via a telematics system to a control station. In such case, preferably the alarm condition is communicated to the control station, the control station then communicating with the mobile phone or a dedicated paging device with the driver to alert him that the system is in intruder detected mode. Given that many vehicles include a GPS system which would allow accurate locating of the vehicle, information relating to the intruder; the vehicle and its location could also be communicated to the police or the immigration authority. The alarm signal may of course also be transmitted directly from the vehicle to a mobile device carried by the driver.

The vehicle may be a truck, lorry, coach, bus or train. The alarm system may also be utilised in an aeroplane. However, the system is particularly useful for trucks and lorries.

The concealment zone is the space in and around the vehicle, which could be entered by an intruder and in which the driver of the vehicle may not be aware of their presence. In the case of a truck or lorry, this concealment zone is typically the cargo carrying space. However, on some vehicles, such as containers or tankers, an intruder may climb on top of the container or tanker-prior to finding an entry into the cargo carrying space. Thus here the concealment zone extends to the space above the load carrying space of the vehicle. The system also provides an anti theft alarm. Often vehicles such as high-sided trucks and lorries are vulnerable to cross winds and it is for this reason that the force only in a substantially vertical direction is to be detected. Preferably the sensor is are arranged such that force applied in a non-vertical direction is not detected by the sensor.

Preferably the threshold value is chosen to be equivalent to a mass of between 10 Kg and 50 Kg entering the concealment zone-thus less than the weight of a small adult. It is extremely unlikely that a small child would enter a vehicle unaccompanied.

The system may include a time delay to allow for inadvertent activation of the system. This is especially important when the alarm signal is transmitted to a remote station. Preferably the alarm signal is transmitted first to the driver's unit so that he can check the situation before an alarm is activated at a remote location-or with the police.

The sensors may be coupled to the alarm generator by a hard, wired connection but may equally be connected by wireless communication. Examples could be by infrared waves. Such an arrangement would be useful in an articulated lorry or for use with a container lorry.

In one configuration of the invention, designed for a truck comprising a tractor unit and trailer, a downwards force applied upon the floor of the trailer can be sensed at the tractor unit. Thus a tractor unit could be arranged to have an intruder alarm system fitted which would continue to operate irrespective of the type of trailer hitched to the tractor unit. Thus as trailers are exchanged, no wiring of the alarm system has to be the trailer currently in use is always alarmed. The sensor may be mounted within an air suspension unit of the vehicle and may be within the tractor unit. Many tractor and trailer units of lorries and trucks have within them an airbag suspension system for weighing the cargo. It is possible for sensors to be incorporated within the airbag system to provide an output indicating downward force within the concealment zone to the alarm system. Such sensors may typically comprise pressure transducers coupled by air lines to the tractor's air bags.

### BRIEF DESCRIPTION OF THE DRAWINGS

Three vehicle intruder alarm systems in accordance with the invention will now be described, by way of example only with reference to the accompanying drawings in which:

FIG. 1 is a schematic perspective view of a first alarm system mounted upon a rigid truck;

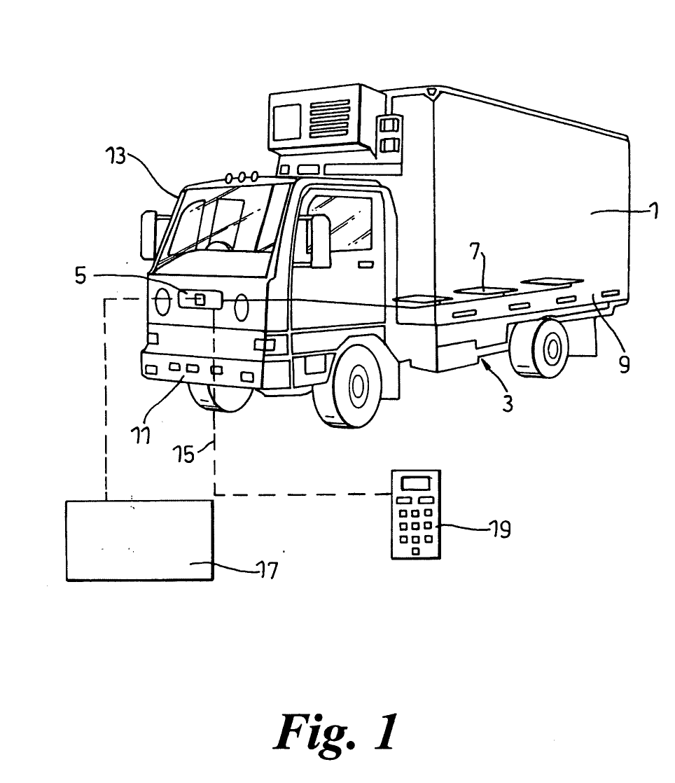

FIGS. 2 and 3 are schematic plan and side elevation views respectively of a tractor and trailer units of an articulated truck to which an alarm system is mounted;

FIG. 4 shows a schematic section through a trailer and illustrates, also schematically, a third example of an alarm system;

FIG. 5 is a schematic block circuit diagram of the third alarm system;

FIG. 6 is a circuit diagram of the power supply part of the circuit shown in FIG. 5;

FIG. 7 is a circuit diagram of the Bridge Amplifier part of the circuit shown in FIG. 5;

FIG. 8 is a circuit diagram of the Filter and Amplifier part of the circuit shown in FIG. 5; and,

FIG. 9 is a circuit diagram of the Detection and Alarm part of the circuit shown in FIG. 5.

### DETAILED DESCRIPTION OF THE PREFERRED EMBODIMENT

A first vehicle intruder alarm system for providing an alarm in the event of unauthorised entry into a concealment zone 1 of a vehicle 3, comprises an activator 5 to activate the system when the vehicle 3 is stationary, at least one sensor, shown schematically at 7 arranged to detect force applied in a substantially vertical direction to the floor 9 of the concealment zone 1, the or each sensor 7 being coupled to alarm generator 11 arranged such that detection of a force above a threshold value by the sensor when the system is activated switches the alarm generator 11 to intruder detected mode to generate an alarm for indicating the presence of an intruder in the concealment zone 1. The vehicle 3 is a rigid truck where the driver sits in a cab 13 remote from the cargo carrying flatbed, which forms the floor 9 of the concealment zone 1. If an intruder were to enter the concealment zone 1, the driver in the cab 13 would not be able to see him.

The alarm generator 11 is part of the telematics unit 15 of the vehicle. When a sensor senses a force downwards over a threshold value of 10 kg, a signal is received by the alarm generator 11 to switch it to intruder detected mode. In this mode, the telematics unit 15 communicates with control station 17 and to the driver's mobile phone 19 to alert the driver to the presence of an intruder. The driver may then take appropriate action to remove the intruder from his vehicle.

In this case the alarm system is activated by an on/off button 21 manually operated by the driver (not shown).

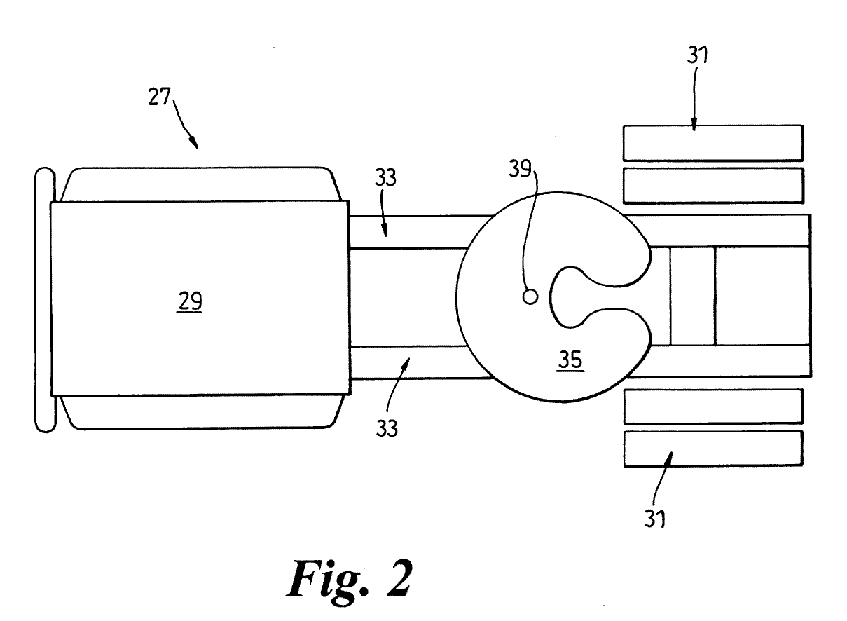

FIGS. 2 and 3 illustrate how the invention can be arranged for providing an alarm in the event of unauthorised entry into a concealment zone within a load carried upon trailer 25 (FIG. 3) of an articulated lorry. It comprises an activator (not shown) for activating the system when the vehicle is either stationary or slow moving on request of the driver—typically by a push button.

The articulated lorry comprises a tractor unit 27 carrying driver's cab 29 supported by a pair of wheels (not shown) and a rear pair of wheels 31. These are connected by chassis 33. Mounted upon chassis 33 is the ‘fifth wheel’ 35, shaped to receive mating pin 37 of trailer 25.

Sensors 41 are mounted upon air suspension units 43 of the trailer 25.

The sensors 41 may be coupled to a control station (not shown) in the cab 29 by wireless connections. Alternatively, they may be hard wired through the standard wiring connector (or Suzy) to the tractor unit.

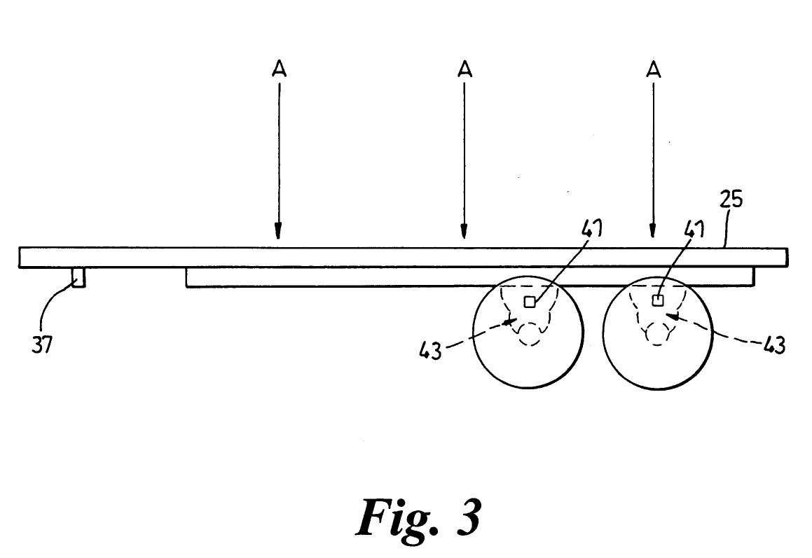

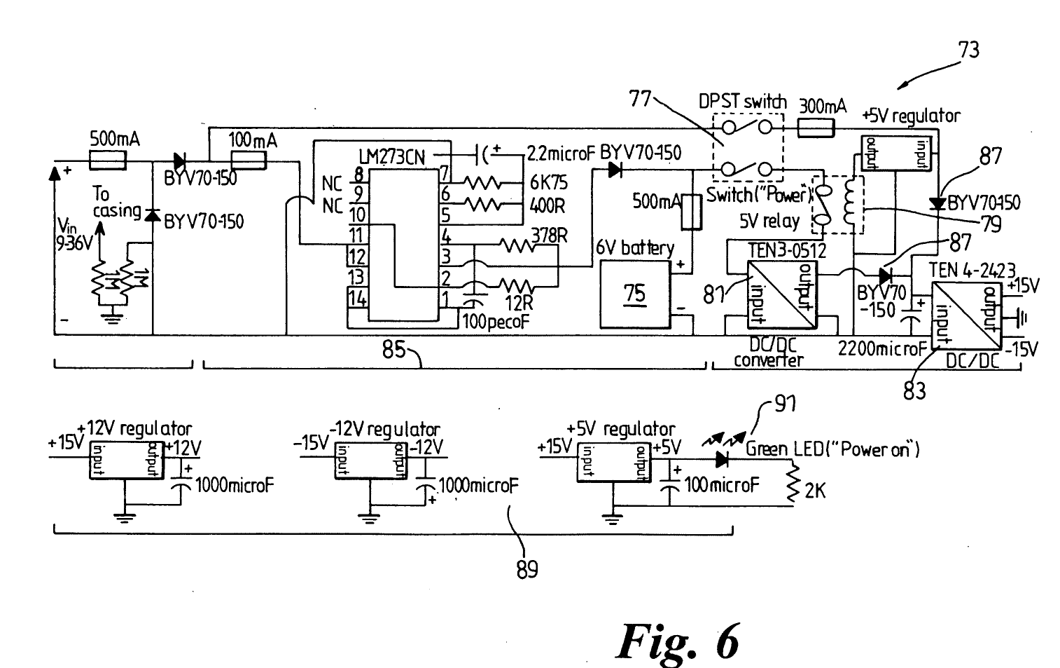

A third example of an intruder alarm is illustrated in FIGS. 4 to 9. Here the alarm system 43 is for use upon a vehicle 45 having an air bag suspension system. The drive axle 47 of the tractor unit 49 is illustrated, in which a pair of air bags 51 are mounted between the axle 47 and the mounting supports 53 which are mounted upon the load carrying area of the tractor. The concealment zone (not shown) is above this area.

The air in the air bags 51 is replenished via air lines 55 which are coupled to a pressurized air supply (not shown). Also coupled to the air line is pressure transducer 57. The choice of a suitable pressure transducer will be readily apparent to the skilled addressee of the specification. In this case it is a strain gauge based transducer. The signal from the transducer 57 is passed through a bridge amplifier circuit 59 to amplify the signal. The amplified signal is then passed through a 1″ stage gain 61 and High Pass filter 63 which removes the DC gain. The signal is then passed through a 2nd stage gain 65 to a low pass filter 67 which removes noise. The signal is then fed through a 3′″ stage gain 69 to the detect and alarm circuit 71.

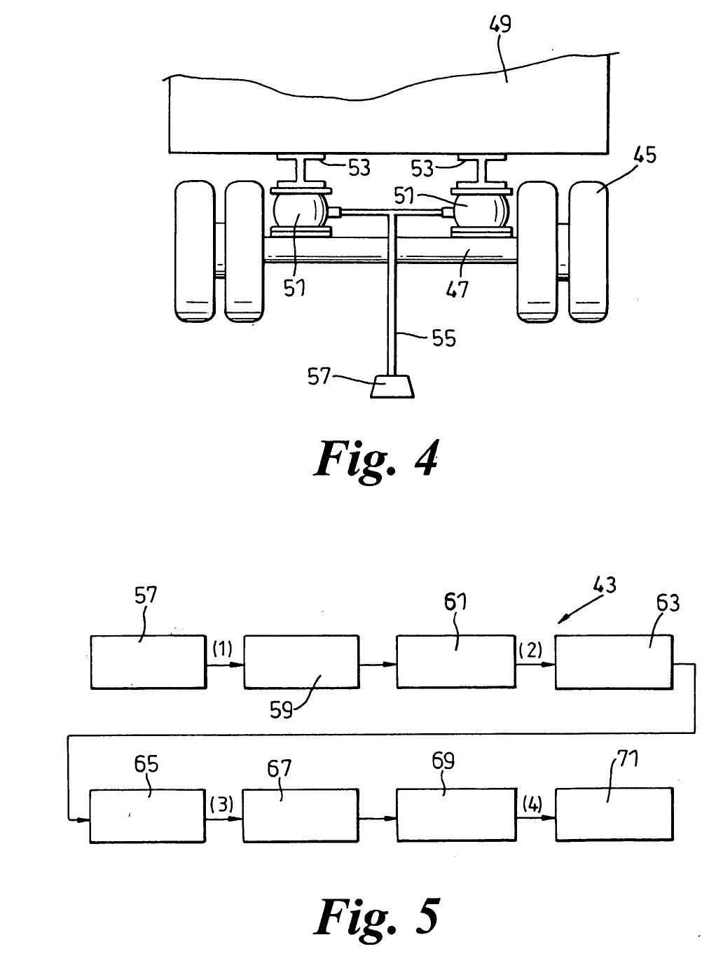

In this case the power supply circuit 73 (FIG. 5) operates from the vehicles own 12 volt supply (up to 14.4V when the engine is running), the 24 Volt supply (up to 28.8V when the engine is running) or an internal 6 Volt battery 75. Power is switched from either supply via a double pole single throw switch 77 (fitted on the dashboard control box) with a relay 79 being used to turn off the battery supply when external power is detected.

In order to make the 6V usable the power is passed through a DC/DC converter 81 to give 12V with the relay 79 being used to prevent power being drained by the DC/DC converter when battery power is not being used.

A second DC/DC converter 83 is used to take in either the external or internal power and turn it into +15 v and −15v.

A battery charging circuit 85 is fitted to trickle charge (low current/low voltage) the battery 75 whenever the unit is connected to an external supply. By using the trickle charge, the charging process can carry on indefinitely without risk of damage to the battery 75.

A pair of diodes 87 is used prior to second DC/DC converter 83 to ensure that the flow of current within the circuitry is in the correct direction.

In order to power the components in the system requiring different supply voltages, smoothing supply circuitry 89 is supplied. One such component is the power on indicator 91.

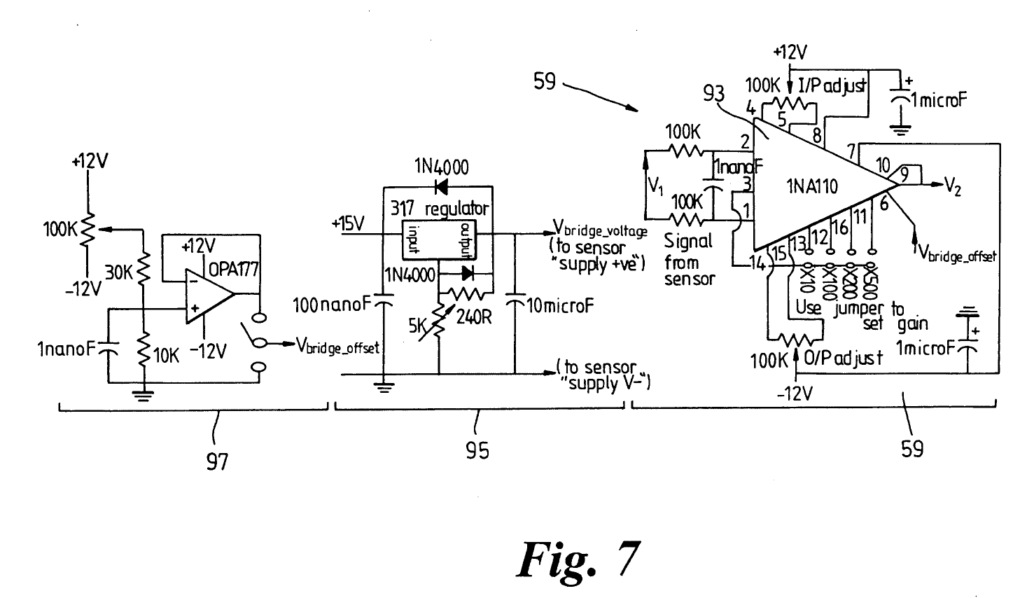

Bridge Amplifier 59 (FIG. 7) comprises amplifier chip 93 into which signals from the sensor are fed. It is powered by power supply voltage 95. An offset voltage is provided by offset voltage adjustment circuit 97.

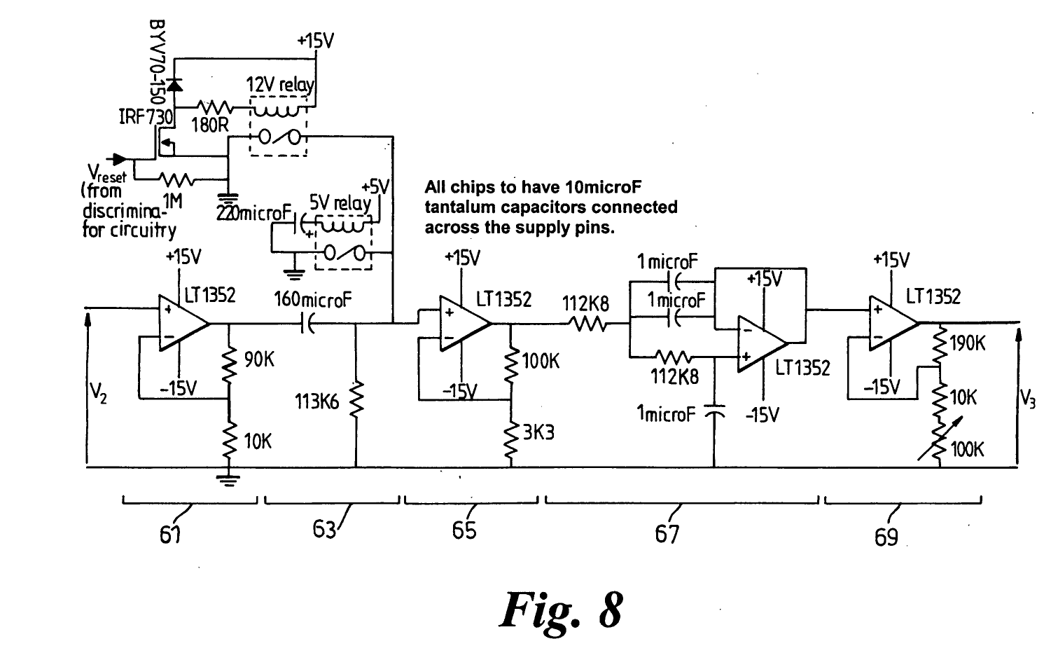

The filter and 1^{st}, 2^{nd} and 3^{rd} gains are shown in more detail in FIG. 8. The high pass filter 63 filters out signals below 0.01 Hz. The low pass filter 67 filters out signals above 1 Hz to remove signal noise and any unwanted vehicle dynamics.

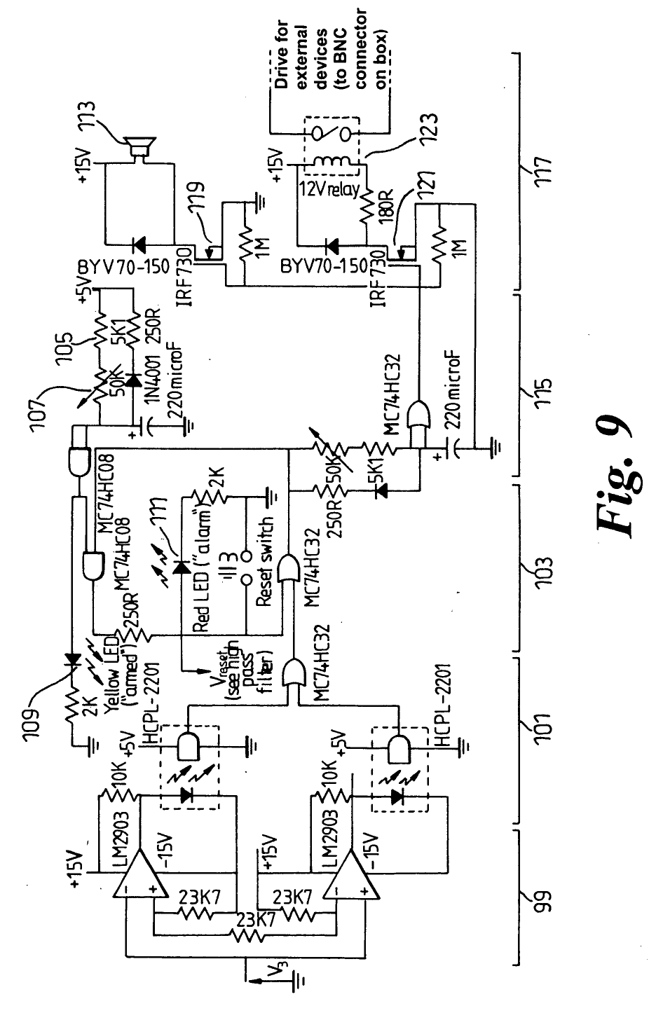

The detection and alarm circuit 71 (FIG. 5) comprises threshold detector 99 (FIG. 9) which is set to be between +5 Volts and −5 Volts. The signal is then converted into logic level signals using converter circuit 101.

On power up, a delay is required before the circuit ‘arms’ itself, for instance to allow the driver time to get out of the cab. The delay is achieved by a resistor-capacitor circuit 105 (FIG. 9) which includes a variable resistor 107 which allows the delay to be adjusted. This signal is then fed through to LED 109 which indicates when the system is armed. This shows in the dashboard box.

The delay signal and threshold breech signals are fed into a latch loop 103. Once the circuit has become armed, even the shortest of signals on the threshold breech line will cause the latch to turn on and stay locked on even after the threshold breech has gone. The threshold breech is indicated by a red light 111, on the dashboard box.

The latch 103 may be reset either by pressing a reset button 113 on the dashboard box or by turning the unit off and on again. The latch loop 103 is not directly used to trigger the audible alarm sounder 113. This is in order to allow the driver to have time to turn the alarm off before the alarm starts sounding. This is achieved by using a second adjustable delay circuit 115. The output from the delay circuit 115 passes to output stage drive circuitry 117. One transistor 119 turns on the audible alarm 113. A second transistor 121 turns on a relay 123, which is coupled to an external device (for example a remote alarm for the driver).

1. A vehicle alarm system comprising means for generating an alarm signal in response to a weight change characterised in that the means for generating the alarm includes a sensor mounted upon or within an air suspension unit of the vehicle.

2. A vehicle alarm system comprising means for generating an alarm signal in response to a weight change wherein the means for generating the alarm includes a sensor for sensing the pressure within an air suspension unit of the vehicle.

3. An alarm system according to claim 1 wherein the sensor is designed to activate the alarm in response to a weight change caused by an intruder entering the vehicle.

4. An alarm system according to claim 1 for a vehicle comprising a tractor (27) and trailer wherein the sensor is linked via an air line to air suspension units of the trailer so as to detect changes of weight of a load carried by the trailer.

5. An alarm system according to claim 1 wherein a low pass filter is arranged to remove, from a sensor output signal, unwanted signal components arising from vehicle dynamics.

6. An alarm system according to claim 1 wherein a high pass filter is arranged to remove, from the sensor output signal, unwanted DC signal variations.
